(19) United States
(12) Patent Application Publication
(10) Pub. No.: US 2004/0216234 A1
(43) Pub. Date: Nov. 4, 2004

(54) Ergonometric tabletop for a laser imaging apparatus

(76) Inventors: Robert H. Wake, Cooper City, FL (US); Margaret Montague, Ft. Lauderdale, FL (US); Vicente Magraner, Miami, FL (US)

Correspondence Address: SHLESINGER, ARKWRIGHT & GARVEY LLP, 3000 South Eads Street, Arlington, VA, 22202, US

(21) Appl. No.: 10/834,030

(22) Filed: Apr. 29, 2004

Related U.S. Application Data
(60) Provisional application No. 60/466,062, filed on Apr. 29, 2003.

(51) Int. Cl. A61G 13/00

(52) U.S. Cl. 5/601; 5/621

(57) ABSTRACT

A tabletop for use in a laser imaging apparatus to support a patient comprises a first support surface including an opening in which the patient's breast is to be disposed for scanning, the first support surface contacting the patient around the breast; and a second support surface at a different height for support of the patient's head and other breast.

### RELATED APPLICATIONS

This application claims the benefit of U.S. Provisional Application Ser. No. 60/466,062, filed Apr. 29, 2003, hereby incorporated by reference.

### FIELD OF THE INVENTION

The present invention relates generally to a diagnostic medical imaging apparatus that employs a near-infrared laser as a radiation source and a detector array with restricted fields of view directed to their own patches of surface of the object being scanned to simultaneously detect the intensity of light exiting from the object for the purpose of reconstructing cross-sectional images of the object, and more particularly to an ergonometric tabletop for use in a laser imaging apparatus.

### BACKGROUND OF THE INVENTION

Cancer of the breast is a major cause of death among the American female population. Effective treatment of this disease is most readily accomplished following early detection of malignant tumors. Major efforts are presently underway to provide mass screening of the population for symptoms of breast tumors. Such screening efforts will require sophisticated, automated equipment to reliably accomplish the detection process.

The x-ray absorption density resolution of present photographic x-ray methods is insufficient to provide reliable early detection of malignant tumors. Research has indicated that the probability of metastasis increases sharply for breast tumors over 1 cm in size. Tumors of this size rarely produce sufficient contrast in a mammogram to be detectable. To produce detectable contrast in photographic mammograms 2-3 cm dimensions are required. Calcium deposits used for inferential detection of tumors in conventional mammography also appear to be associated with tumors of large size. For these reasons, photographic mammography has been relatively ineffective in the detection of this condition.

Most mammographic apparatus in use today in clinics and hospitals require breast compression techniques which are uncomfortable at best and in many cases painful to the patient. In addition, x-rays constitute ionizing radiation which injects a further risk factor into the use of mammographic techniques as most universally employed.

Ultrasound has also been suggested as in U.S. Pat. No. 4,075,883, which requires that the breast be immersed in a fluid-filled scanning chamber. U.S. Pat. No. 3,973,126 also requires that the breast be immersed in a fluid-filled chamber for an x-ray scanning technique.

In recent times, the use of light and more specifically laser light to noninvasively peer inside the body to reveal the interior structure has been investigated. This technique is called optical imaging. Optical imaging and spectroscopy are key components of optical tomography. Rapid progress over the past decade has brought optical tomography to the brink of clinical usefulness. Optical wavelength photons do not penetrate in vivo tissue is a straight line as do x-ray photons. This phenomenon causes the light photons to scatter inside the tissue before the photons emerge out of the scanned sample.

Because x-ray photon propagation is essentially straight-line, relatively straight forward techniques based on the Radon transform have been devised to produce computed tomography images through use of computer algorithms. Multiple measurements are made through 360° around the scanned object. These measurements known as projections are used to backproject the data to create an image representative of the interior of the scanned object.

In optical tomography, the process of acquiring the data that will ultimately be used for image reconstruction is the first important step. Light photon propagation is not straight-line and techniques to produce cross-section images are mathematically intensive. To achieve adequate spatial resolution, multiple sensors are employed to measure photon flux density at small patches on the surface of the scanned object. The volume of an average female breast results in the requirement that data must be acquired from a large number of patches. The photon beam attenuation induced by breast tissue reduces the available photon flux to a extremely low level and requires sophisticated techniques to capture the low level signals.

U.S. Pat. No. 5,692,511 discloses such a laser imaging apparatus. In this apparatus, the detector housings (collimators) are perpendicular to the orbit axis, therefore parallel to the patient's chest wall. The detector housings (collimators) for any given slice lie in a plane, the optical plane or slice plane. Consequently, the detector array is “planar”.

The use of a planar detector array dictates that the patient support surface (the tabletop) surrounding the breast be planar, flat. However, a more desirable patient support surface would allow vertical relief for the patient's shoulder, arms, other breast and head to provide comfort to the patient during scanning.

### OBJECTS AND SUMMARY OF THE INVENTION

It is an object of the present invention to provide vertical relief in a horizontal patient support surface such that patient body portions adjacent to the scanned breast may be below the plane of the scan, thereby providing a more comfortable support surface for the patient's body during scanning.

It is another object of the present invention to provide a tabletop to support a patient during scanning that provides support surfaces at different heights to accommodate the other parts of the body not within the scanning chamber, thereby enhancing the patient's comfort and thus encouraging the patient to remain still during scanning.

In summary, the present invention provides an ergonometric tabletop for use in a laser imaging apparatus to support a patient, comprising a first support surface including an opening in which the patient's breast is to be disposed for scanning, the first support surface contacting the patient around the breast; and a second support surface at a different height for support of the patient's head and other breast.

These and other objectives of the present invention will become apparent from the following detailed description.

### BRIEF DESCRIPTIONS OF THE DRAWINGS

FIG. 1 is a schematic side elevational view of a scanning apparatus with a planar detector array configuration, showing a prone patient positioned for an optical tomographic study, with one breast pendent within the scanning chamber.

FIG. 2 is a schematic top view of the scanning chamber of FIG. 1, showing the planar detector array, consisting of a plurality of detectors disposed around an object being scanned and a laser light source.

FIG. 3 is a schematic cross-sectional view through the planar detector array of FIG. 2, showing the laser light source and the detectors.

FIG. 4 is a schematic side elevational view of a scanning apparatus with a tabletop having vertical relief around the breast and showing a prone patient positioned for an optical tomographic study, with one breast pendent within the scanning chamber.

FIG. 5A is a perspective top view of the scanning apparatus of FIG. 4, showing the tabletop with vertical relief around the breast and the scanning chamber.

FIG. 5B is a top plan view of FIG. 5A.

FIG. 6 is a block diagram of the data acquisition system that supports the detector array of FIGS. 2 and 3.

### DETAILED DESCRIPTION OF THE INVENTION

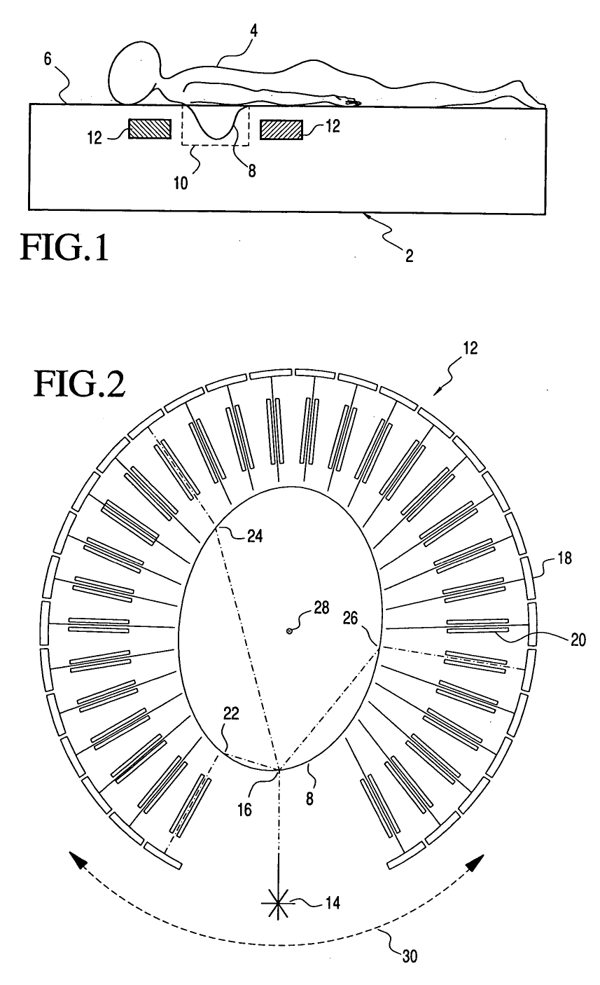

Referring first to FIG. 1, a scanning apparatus 2, as described in U.S. Pat. Nos. 5,692,511 and 6,100,520, supports a prone patient 4 on an essentially flat top surface 6. The patient's breast 8 is pendent within a scanning chamber 10, around which orbits a planar detector array 12. The planar detector array 12 orbits typically 360° around the vertical axis of the scanning chamber 10 and increments vertically between orbits to image successive slice planes. This is repeated until all the slice planes of the breast have been scanned. Since the surface 6 is a single level, flat surface, the patient's head and shoulder tend to contact the table surface, causing discomfort and lifting the breast somewhat out of the scanning chamber.

FIG. 2 shows a top view of the planar detector array 12 from FIG. 1. A laser source 14 generates a laser beams that impinges on the scanned object (breast) 8 at a point 16. A plurality of detectors 18 defines an arc surrounding the scanned object. A collimator 20 defines each detector's field of view to a small area on the surface of the scanned object. Light enters the scanned object at point 16 and exits at every point on its circumference. Three exit points 22, 24 and 26 are shown, corresponding to three detectors. The entire mechanism rotates around the center of orbit rotation 28, as indicated by the curved double-headed arrow 30.

In the preferred implementation, every detector in the array is collimated, aiming at the center of orbit rotation 28. The laser source also points toward the center of rotation. The detectors are spaced at equal angular increments around the center of rotation. The orbit rotation is preferably alternately 360° clockwise for one (horizontal) slice plane, and 360° counterclockwise for the next slice plane.

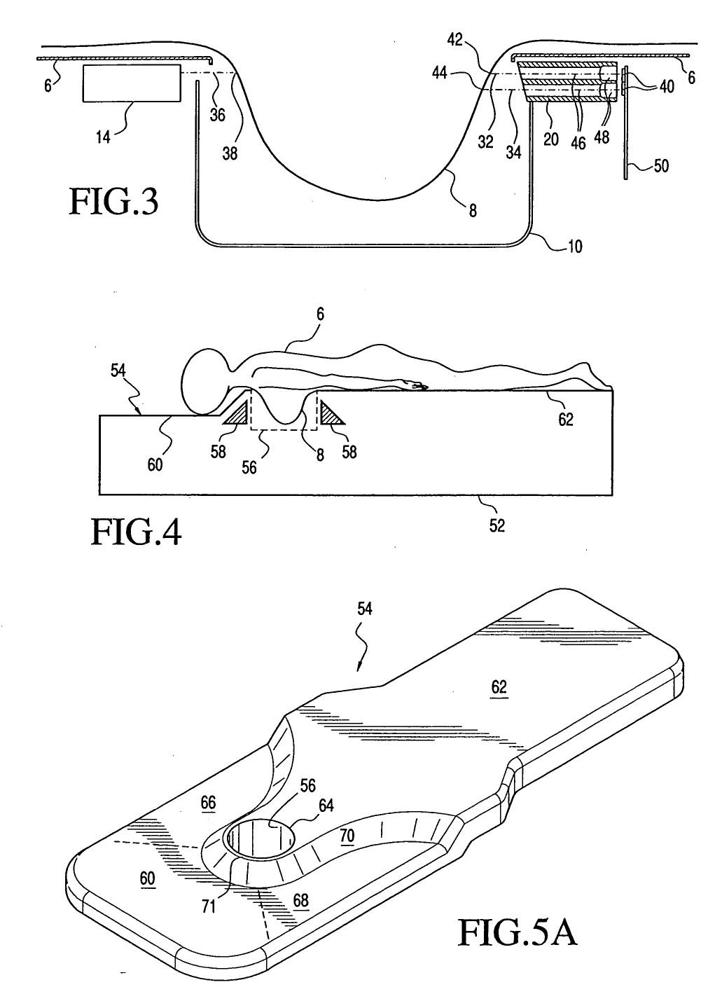

FIG. 3 shows a vertical cross-section through the planar detector array 12 of FIG. 2. The planar detector array 12 is shown as simultaneously imaging two adjacent slices 32 and 34, though any number of slices can be imaged simultaneously, as disclosed in U.S. Pat. No. 6,100,520. The patient's breast 8 is pendent within the scanning chamber 10. The patient is supported by the scanning apparatus' tabletop surface 6. The laser 14 projects a coherent light beam 36 which impinges on the patient's breast at point 38.

Two photodetectors 40, one each from the two slice planes 32 and 34, are shown imaging points 42 and 44 on the breast for the upper and lower slices, respectively. The opaque collimator 20 is shown as a single physical entity with two collimating channels 46. The collimating channels 46 can be round, square, hexagonal, triangular or any other cross-sectional shape. The collimator 20 advantageously restricts the field of view of each detector assembly to a small, defined area on the surface of the scanned object. At the rear of each collimating channel is a lens 48, which focuses the light propagating down the collimating channel onto the photodetector 40. The lenses are shown as plano-convex, but can be biconvex or can be eliminated if the photodetector's active area were larger than the collimating channel's cross-sectional area. The photodetectors are connected to a signal processing system 50 for amplification and analog-to-digital conversion.

The laser 14 can be a semiconductor diode laser, a solid-state laser or any other near-infrared light source. The photodetectors 40 can be photodiodes, avalanche photodiodes, phototransistors, photomultiplier tubes, microchannel plates or any other photosensitive device that converts incoming light photons to an electrical signal. The photodetectors provide the means for detecting the laser beam after passing through the breast.

FIG. 4 shows a schematic side elevational view of a scanning apparatus 52 with a tabletop surface 54 shaped so as to allow vertical relief for the patient's shoulder, arms, head and opposite breast. A prone patient 4 is positioned for an optical tomographic study, with one breast 8 pendent within a scanning chamber 56. A folded-optics detector array 58, shown schematically, orbits typically 360° around the vertical orbital axis of the scanning chamber 56 and increments vertically downward between orbits to image successive slice planes. This is repeated until all the slice planes of the object have been scanned.

The tabletop surface 54 has a lower level surface 60 and a higher level surface 62. The lower level surface 60 advantageously provides relief and support for the patient's shoulder, arms, head and opposite breast. The higher level surface 62 advantageously provides support for the patient's lower body and legs.

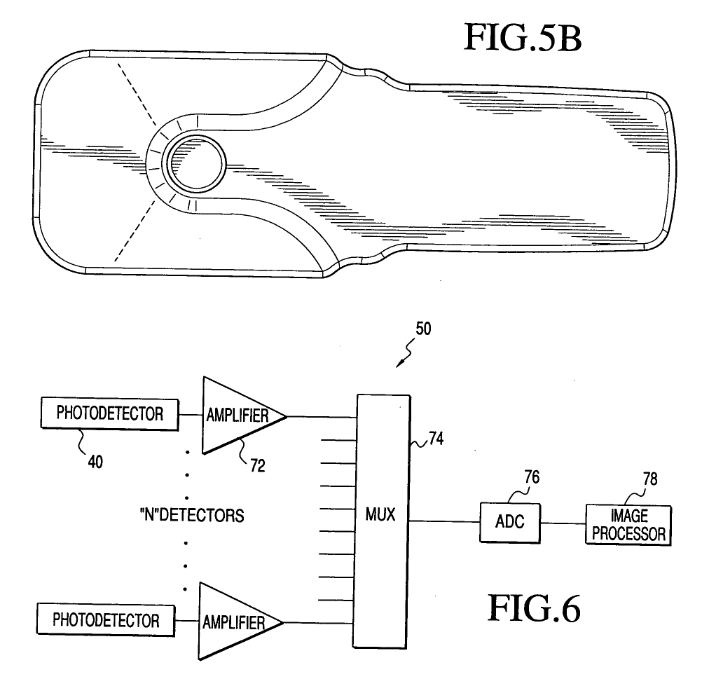

FIG. 5A shows the scanning apparatus tabletop 54 in perspective. The patient's breast 8 would be pendent in the scanning chamber 56. The patient's torso and legs are supported by the surface 62, which is advantageously at the same level as the opening 64 of the scanning chamber 56. The surface 60 supports the patient's head, advantageously allowing the head to be positioned below the top of the scanning chamber for comfort. Assuming the patient's left breast is positioned in the scanning chamber 56, surface 66 advantageously provides relief for the patient's right breast and surface 68 provides relief for the patient's left shoulder and a resting place for the patient's left arm. The roles of the surfaces 66 and 68 are reversed for scanning the right breast. The tabletop 54 is preferably symmetrical in plan view, as shown in FIG. 5B.

Surfaces 60, 66 and 68 are at the same level in the preferred embodiment, approximately 7 centimeters below the rim of the scanning chamber 56. However, it should be understood that these surfaces can be at different levels. A transition surface 70 between the higher level surface 62 and the lower level surfaces 60, 66 and 68 is preferably slanted or ramped to provide room underneath for the detector array 58. The surface 62 preferably tapers toward the opening 64. The transition surface 70 also provides support for parts of the patient's body immediately adjacent the breast being scanned. A horizontal flange or lip 71 around the opening 64 provides further comfortable support to the peripheral base area of the breast being scanned.

The preferred embodiment has the patient lying prone with the breast pendent in the scanning chamber. Although the tabletop is shown horizontal for a patient in prone position, it should be understood that the tabletop can be in any position.

FIG. 6 shows the signal processing system 50. A plurality of photodetectors 40 are connected to a plurality of amplifiers 72. In the preferred embodiment, the photodetectors are photodiodes and the amplifiers are integrators. The amplifiers are connected to a multiplexer (MUX) 74 which presents one of “N” amplifier outputs to an analog-to-digital converter (ADC) 76. The digital output of the ADC is connected to an image processor 78, typically a general-purpose computer. The image processor performs the reconstruction computations to create cross-sectional images from the projection data collected by the scanning apparatus. Multiple MUXes and ADCs can be employed in order to decrease the data acquisition time.

A separate copending application describes the folded optics detector array 58 and will not be described herein.

While this invention has been described as having a preferred design, it is understood that it is capable of further modification, uses and/or adaptations of the invention following in general the principle of the invention and including such departures from the present disclosure as come within known or customary practice in the art to which the invention pertains, and as may be applied to the essential features set forth, and fall within the scope of the invention or the limits of the appended claims.

We claim:

1. A tabletop for use in a laser imaging apparatus to support a patient, comprising:
a) a first support surface including an opening in which the patient's breast is to be disposed for scanning, said first support surface contacting the patient around the breast; and
b) a second support surface at a different height for support of the patient's head and other breast.

2. A tabletop as in claim 1, wherein said first support surface is horizontal so that the patient is prone on the tabletop and said second support surface is below said first support surface.

3. A tabletop as in claim 1, wherein said tabletop is symmetrical in plan view.

4. A tabletop as in claim 1, wherein said first support surface tapers toward said opening.

5. A tabletop as in claim 1, wherein said opening includes a lip.

6. A tabletop as in claim 1, and further comprising a ramped transition surface between said first and second support surfaces.

7. A tabletop as in claim 1, wherein:
a) said second support surface is divided into top, left and right portions;
b) said top portion provides support to the patient's head;
c) said left and right portions provide support to the person's left and right breasts, respectively.

8. A tabletop as in claim 7, wherein said top, left and right portions are at the same height.
